(19) United States
(12) Patent Application Publication
(10) Pub. No.: US 2008/0130151 A1
(43) Pub. Date: Jun. 5, 2008

(54) Method and device to mount electronic devices vertically

(76) Inventors: Jonathan Schwartz, Tel Aviv (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 11/998,932

(22) Filed: Dec. 4, 2007

(30) Foreign Application Priority Data
Dec. 5, 2006 (IL) 179838

(51) Int. Cl. G02B 5/08; H03H 7/01

(52) U.S. Cl. 359/862; 333/167

(57) ABSTRACT

A series of reflecting mirrors to transfer waves from a portable remote control device to control electronic devices where the wave receiving eye of the electronic device is not in uninterrupted alignment with the remote control device. A wave filter to block certain definable instructions from reaching the wave receiving eye.

### FIELD OF THE INVENTION

This invention is in the field of storage and holding equipment. More specifically, the present invention provides a means to operate by remote control, electronic devices and/or devices with a status display, for example home theater equipment, A/V devices like, DVD player, VCR and the like. This invention enables such electronic devices to be mounted in a vertical position thus saving floor and/or shelf space, without impairing the ability to operate the same by means of remote control devices.

### BACKGROUND OF THE INVENTION

In most houses today there are many electronic devices. The television is a prime example. Sometimes there is a smart home controller that controls via a computer program or an electronic chip, pre-programmed instructions or real-time instructions. Such a smart home controller could control many electronic devices like the television, DVD player, a satellite receiver, a VCR and similar devices that can be operated by remote control.

Most of the above mentioned devices can be operated by remote control. Even where a particular device is not controllable by remote control, but the smart home controller is connected to the device, then a remote control instruction to the home theater could control the other device.

Remote control devices usually use infra-red technology, whereby the user presses certain buttons on the remote device in order to operate, close or alter the program, where the device has optional programs.

Infra-red uses part of the light spectrum invisible to the human eye. Electronic devices that are made to be operated by remote control, have their infra-red receiver facing in such a direction that the instructing rays from the remote control device can conveniently reach the said receiver. There must be uninterrupted uncluttered air space between the remote control and the receiver.

Many electronic devices today are made to fit under the CRT type television which means they are made to be the approximate width and depth as the television and with a relatively small height. This low flat size tends to use a lot of floor space.

The trend today is towards LCD or plasma screens for television sets. These relatively thin televisions are often mounted on the wall or on a wall mounted remote controlled movable screen holder.

This growing phenomenon leaves the other electronic devices, like for example, a DVD, without their television housing and without a convenient and protected place for storage. Floor space is therefore not saved by having an LCD or plasma television set, if the old housing under the CRT TV is still used.

There could be other considerations against the placing these electronic devices flat on the floor or on a shelf, for example vulnerability to damage or internal home design requirements.

This invention comes to offer a solution to this problem of housing or storing large surface area, low height electronic devices whereby their ability to receive instruction from a remote control device will not be impaired.

The invention applies to any device that is required to be controlled and operated by remote control where the receiving window does not face the user whether or not housed or stored in a housing.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

An object of this invention is to have a method of operating electronic devices by remote control where the receiving window for receiving operating instructions does not face the direction of the operator.

Another object of this invention is to have a means of holding remote control operated devices in a vertical position.

Another object of this invention is to save floor and/or shelf space.

Another object of this invention is to provide a method to give electronic remote control instruction using for example, infra red where there is no open uninterrupted uncluttered air space between the remote control and the electronic device.

Another object of this invention is to block certain infra-red remote instruction where the said instruction could cause damage or be otherwise undesirable.

Another object of this invention is to use reflecting mirrors to see the writing on the screen of the said electronic devices when the said writing is not directly visible.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. 1 is a schematic depiction of an optional housing for the present invention.

FIG. 2 is a schematic depiction of the said housing open and an electronic device.

FIG. 3 is a sketch of a light or other wave hitting two reflective surfaces.

FIG. 4 is a schematic depiction of the said housing from the end view showing a method of operation of this invention.

FIG. 5 is a schematic depiction of the present invention showing an alternate path for the remote controller's waves.

FIG. 6 is a schematic depiction of this invention as a stand alone device without a housing unit.

FIG. 7 is a schematic depiction of an optional method of adjusting the position of the reflecting mirrors.

FIG. 8 is a schematic depiction of an optional lip addition to the CD tray.

FIG. 9 is a schematic depiction of a filter for infra-red waves.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

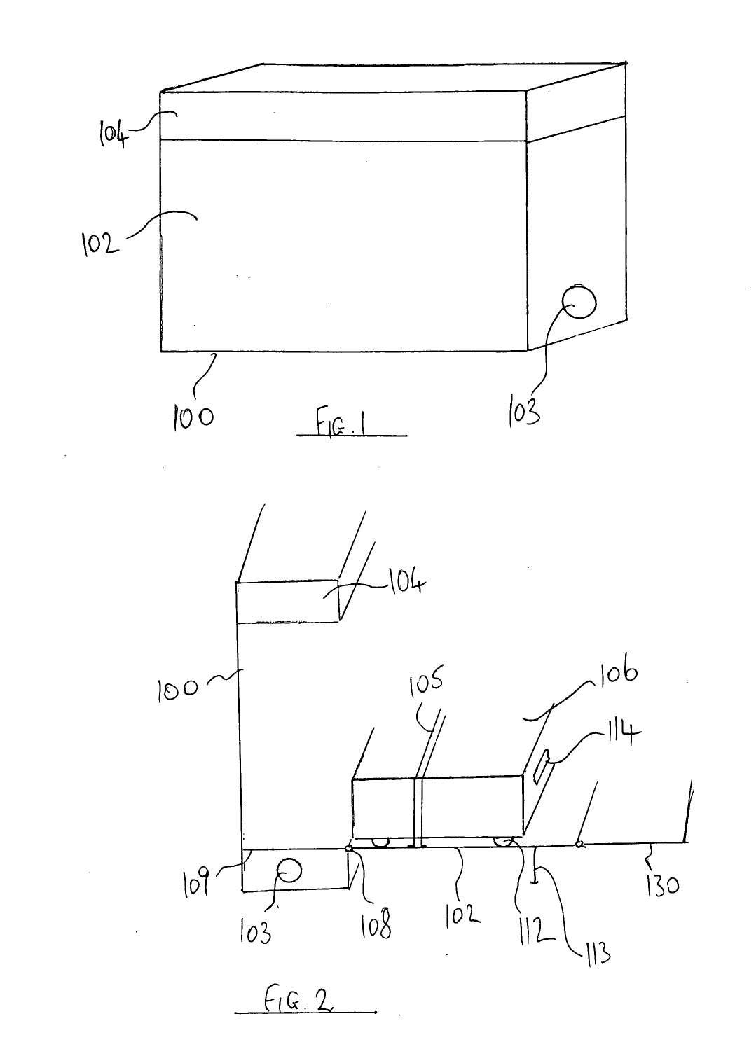

FIG. 1 shows a possible housing for this invention. It is an empty box 100 made from any suitable material like wood, plastic or the like. One side 102 could be used for a door for inserting or extracting the electronic device being used with this invention or as a window if a screen of a plasma or LCD type television were placed behind the window or the plasma type television could be attached to its external wall. The space 104 of the box 100 would be kept free of any electronic devices. Some elements of this invention could be housed in that space 104 and will be more fully described in FIG. 4.

The hole 103 is for electric and other cables to go from their source to the electronic device inside the box 100. The hole 103 could be on any face of the box 100 to conveniently allow the said cables to be orderly.

FIG. 2 shows an optional method to place an electronic device 106 inside the housing 100. The door 102 opens at the hinge 108 and rests in a horizontal position with, for example, the aid of folding leg 113. The said horizontal position could be achieved in other ways for example, with the aid of a cord or wire inside box 100, preventing the door 102 from opening more than a set amount. The electronic device 106 could be brought onto the open door 102 before being turned into a vertical position on the raised shelf 109.

A strap 105, for example, could be used to hold the electronic device from slipping when being turned upright. The door 102 could then be closed. The electric cables of the electronic device 106 would pass under the shelf 109 and out through the hole 103. This process of opening the door 102 could be sometimes a one-time happening when the device is initially installed in box 100. In a case where access to the front of the device 106 is needed on a frequent basis, the device 106 could easily be turned onto its legs 112 by opening door 102. An example of this need could be if the only way to insert and eject discs is from the front of the device 106. When the door 102 is opened there would need to be some slack in the electric cables to prevent tension in those cables. This slack could be housed in the space under the shelf 109.

The housing 104 for the reflecting mirrors is described in more detail in FIG. 4.

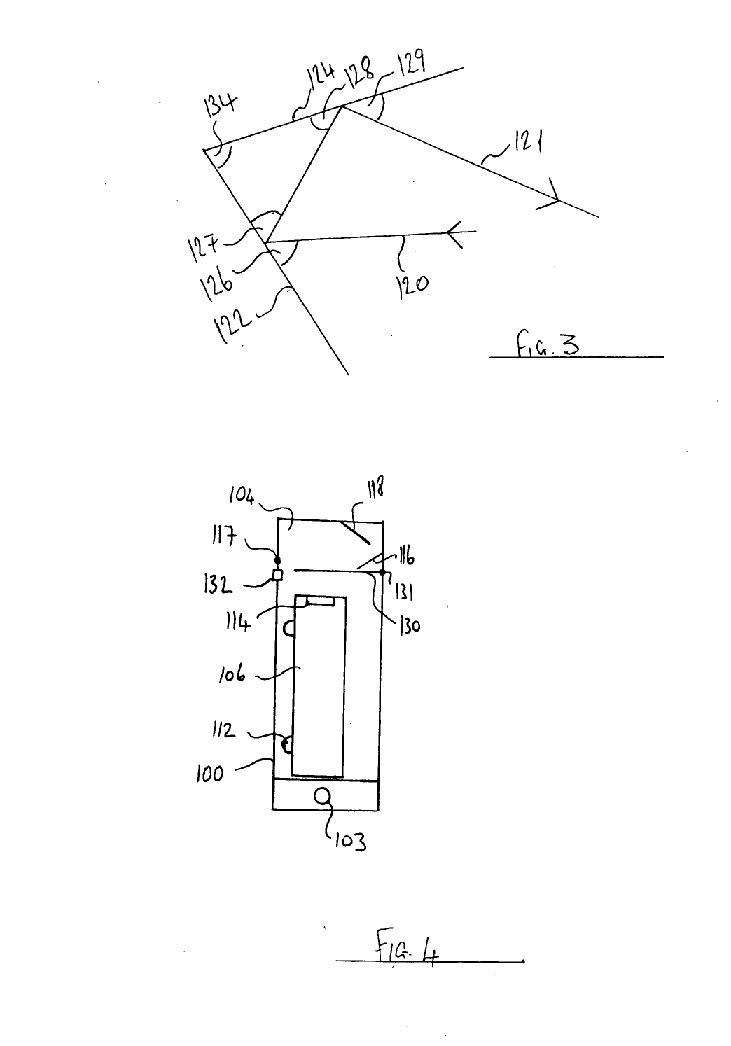

FIG. 3 shows the path of a wave 120 as it hits the first reflective surface 122 and rebounds to the second reflective surface 124. The physics principle involved in this invention is that the angle of incidence equals the angle of reflection, when light or other types of wave hit a reflective surface. The first angle of incidence 126 equals the first angle of reflection 127. The wave continues on its path until it collides with the second reflective surface 124. The wave 120 rebounds again and here also, the second angle of incidence 128 equals the second angle of reflection 129. The angles 126 and 127 are not necessarily equal to angles 128 and 129 respectively unless angle 126 is 45° and angle 134 is 90°.

The reflective material 122 is any suitable material that reflects waves truly, like for example, a mirror or a prism. Adjustment of the angle 134 by moving the angle of the reflecting surfaces 122 and 124 will enable the final reflected wave 121 to reach the intended target, being, in this invention, the receiving eye FIG. 2 114.

FIG. 4 shows the cross-sectional end view of this invention. The box 100 houses the electronic device 106, which is lying on its end in an upright position. This is so even though the normal way for this device to stand is on its feet 112. The receiving eye 114 which normally faces frontward, is facing upward. In this situation, in the absence of this invention, the receiving eye 114 would not be able to receive operating instructions from the remote control unit, because the remote control waves do not have a straight uninterrupted path to the receiver eye 114.

There are two surfaces for wave reflection 116 and 118. The invention is not limited to two such surfaces.

The remote control wave could be directed at the first reflective surface 116. The wave would reflect off the surface 116 and onto surface 118 as described in relation to FIG. 3. The angles of the surface would be fixed, with an option for adjustment, so that the final reflected wave will enter the receiving eye 114 of the electronic device 106. The optional adjustment is necessary when the electronic device 106 is exchanged for a different one whose receiving eye 114 is in a different position.

The side of box 100 could be closed except for the section at the top 104 that would be left open and uncluttered to enable waves to freely enter.

A difficulty encountered with turning these electronic devices to a vertical position is that when CD discs are used, they may slip off their designated tray before the tray slides shut. Once the said tray closes the disc is held firmly in place and the fact that the disc is vertical is not a hazard. However, in the short time between placing the disc on the tray and the closing of the tray, the disc could slip out of place.

A solution to this problem is to load and eject the disc only when the electronic device 106 is horizontal. This process was described in relation to FIG. 2. However, there is a need to prevent automatic ejection and ejection by use of the remote control device. Automatic ejection is prevented by disenabling that feature in the electronic device 106. The remote control eject function could be disabled by using an infra-red filter device 132. This filter device is shown in greater detail in FIG. 9. The filter device 132 takes incoming infra-red waves, filters out pre-determined infra-red commands and emits the remaining infra-red commands that give the appropriate instruction to the electronic device 106. In the case of this invention the filtered wavelengths would be those relevant to operate the eject feature. In this way the ejection of discs could be prevented when the electronic device is in a position other than horizontal. In the horizontal position the ejection could be done using the manually operated eject button.

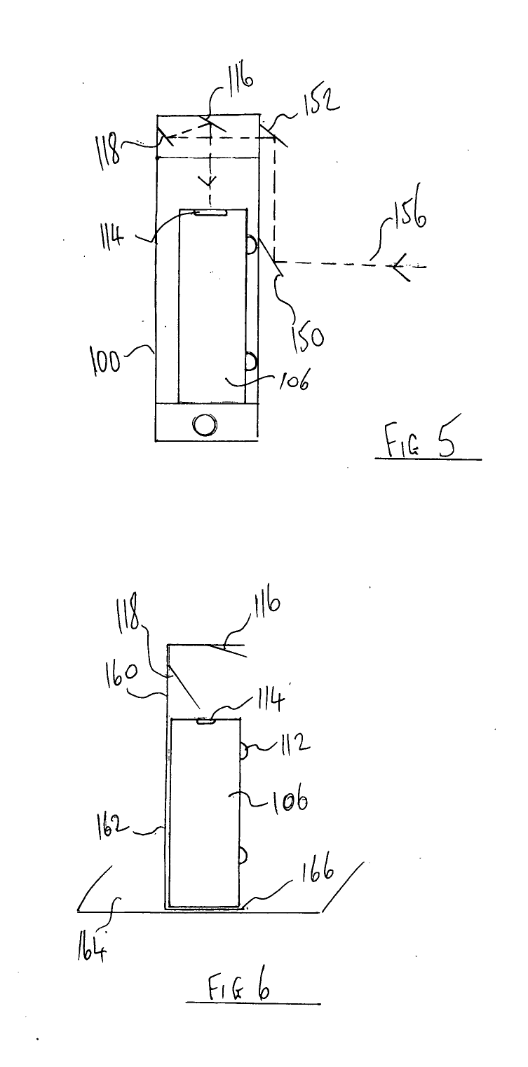

The blocking screen 130 is pivotally attached to the box 100 at hinge 131. The blocking screen 130 is made from a transparent material that allows light to pass through but does not allow infra-red to pass through. It is desirable for light to pass through to enable the user to see what is written on the front screen, as described in relation to FIG. 5.

A possible alternative method of dealing with discs is for the top section 104 of box 100 to be on a hinge 117 whereby access to the discs is available by lifting the section 104. The difficulty with CD discs slipping off their tray could be dealt with by having a disc tray with a protection lip as shown in FIG. 8 180. Another possible method of holding the disc from slipping is by means of clips, as known in the art. FIG. 5 is another embodiment of this invention. Here some of the reflecting surfaces 150 and 152 are affixed adjustably on the outside of the box 100. They reflect the wave path to the internal reflecting surfaces 118 and 116 respectively. The path of the remote control wave is shown by an intermittent line 156 until it reaches the receiving eye 114. In the case of DVD and other devices using CD discs the infra-red filter FIG. 4 132 and FIG. 9, would be used. Also there would be a blocking screen FIG. 4 130 to prevent instruction being given by the remote control device direct to the electronic device 106. The said instruction would be given via the infra-red filter FIG. 4 132 and FIG. 9. In this case the reflecting surfaces 116,118, 150 and 152 would be used for one function only, namely, for the user to look at surface 150 to see what is written on the screen on the front of the electronic device 106. The other use of the said reflecting surfaces namely, to enable the remote control to give instruction via the receiving eye 114, would be blocked by the blocking screen FIG. 4 130.

FIG. 6 is another embodiment of this invention. In this case there is no box. The electronic device 106 stands on its back with its feet 112 facing sideways. There is a frame 160 that could be attached to the electronic device 106. Alternatively, the vertical part of frame 160 could continue down 162 to the surface 164 with a right angled base piece 166. This latter option would facilitate changes of electronic devices as the latter's weight would hold the frame 160 firmly in place, and would avoid physical attachments to any particular electronic device 106.

On this frame 160 would be affixed the adjustable reflecting devices 118 and 116.

In other respects this device would operate as the previously described devices with or without their various options, like for example the infra-red filter FIG. 4 132 and the blocking screen FIG. 4 130.

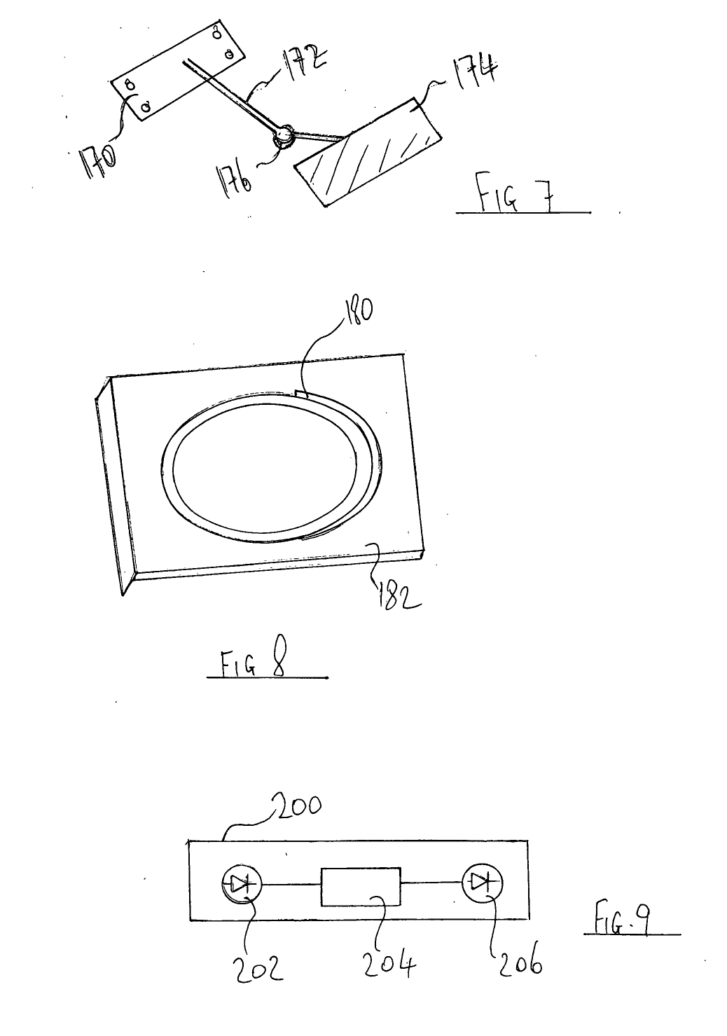

FIG. 7 shows an optional method of adjusting the position of the reflecting mirrors. Throughout this description reference has been made to fixed adjustable reflecting mirrors. The requirement for these reflecting devices to be fixed is to ensure that the instruction waves emitted by the remote control device consistently reach the receiving eye of the electronic device. When the infra-red filter FIG. 4 132 is being used, the said reflecting mirrors need to be held in a fixed position to enable the electronic front screen to be viewed. An unintentional movement of either the electronic device or the reflective mirrors will prevent the proper working of this invention.

However, it could happen that the electronic device is moved a little or is positioned other than vertical or the electronic device is replaced with a different one and the receiving eye of the new device is in a different position from the previous one. In these cases the position of the reflecting mirrors will need to be adjusted to a new fixed position.

The device could be based on the principle of the vehicle rear view mirror as is well known in the art. The back plate 170 is firmly affixed to the box FIG. 1 100 or frame FIG. 6 160. The extension arm 172 would be fixed to the plate 170 at one end and at the other end would have a socket 176 for holding a bearing. The reflecting surface 174 would be attached to an arm with a bearing that fits the socket 176. The said fitting would be such that not less than reasonable hand force would be able to move the bearing in the socket 176.

As described above these reflecting surfaces 174 have a dual purpose, namely to re-direct the infra-red waves coming from the remote control device to the receiving eye FIG. 2 114 of the electronic device. The second function is when a CD disc is used and the wave blocker FIG. 4 130 is in place then the reflecting surfaces 174 are to reflect what is displayed on the screen on the front face of the electronic device FIG. 2 106 to the user of the device. The said user can not see directly what is written on the said screen as it faces upward. The reflecting devices FIG. 4 116 and 118 or FIG. 5 116, 118, 150 and 152 enable the user to see what is written on the said screen. There needs to be an even number of reflecting devices in these reflector arrangements so that the writing is seen in the same direction as the original writing on the said screen.

FIG. 8 shows the optional lip 180 to prevent a CD disc and the like from moving off its tray 182 when the electronic device FIG. 2 106 is turned to a vertical or near vertical position.

FIG. 9 is a diagram of an infra-red filter 200. It consists of an infra-red receiving section 202 which receives the infra-red waves from the remote control device. The said waves pass through the filter 204 which is programmed to prevent certain infra-red commands from passing through and to allow others to pass through to the transmitter section 206. The transmitting section 206 transmits the infra-red instruction to the receiving eye FIG. 2 114 of the electronic device FIG. 2 106.

The infra-red filter 204 could be programmable by the user to recognize the infra-red commands that are undesirable to pass through to the transmitter 206.

What is claimed:

1. An arrangement of reflectors for remotely and wirelessly operating an electronic device where the wave receiving eye of the said electronic device is not directly in line with the remote control device that sends out instruction using infra-red or other waves comprising,
a box to house the said electronic device and to house at least one reflector,
a compartment in the said box to accommodate and provide an entry and exit for cables and wires to and from the said electronic device,
a means to hold the said reflectors at specific angles relative to each other and specific angles relative to the said receiving eye,
a means to adjust the angles of the said reflectors, and
a wave filter to block certain commands emitted by the said remote control device.

2. A arrangement of reflectors as claimed in claim 1 wherein the said blocking is achieved with a transparent infra-red blocking screen.

3. A arrangement of reflectors as claimed in claim 1 wherein the said wave filter is an electronic wave filter whereby specific infra-red or other waves can be blocked from reaching the electronic device.

4. A arrangement of reflectors as claimed in claim 3 wherein the said wave filter is programmable with the wavelengths to be filtered out and blocked from reaching the said receiving eye.

5. A arrangement of reflectors as claimed in claim 3 wherein the said wave filter accepts instruction by the user to recognize the wavelength to be filtered out and blocked from reaching the said receiving eye.

6. A arrangement of reflectors as claimed in claim 3 wherein the said wave filter operates by emitting a disrupting constant light beam that prevents the unwanted waves from reaching the said receiving eye.

7. A arrangement of reflectors as claimed in claim 1 wherein the housing for the said reflecting mirrors is hinged to the said box.

8. A arrangement of reflectors as claimed in claim 1 wherein the said reflecting mirrors are prisms.

9. A arrangement of reflectors for remotely and wirelessly operating an electronic device where the receiving eye of the said device is not directly in line with the remote control device that sends out instruction using infra-red or other waves comprising,
a frame to hold at least one reflecting mirror,
a means to hold the said reflecting mirrors at specific angles relative to each other and specific angles relative to the said receiving eye,
a means to adjust the said angles of the said reflecting mirrors, and
a means to block certain commands emitted by the said remote control device.

10. A arrangement of reflectors as claimed in claim 9 wherein the said blocking is achieved with a transparent infra-red blocking screen.

11. A arrangement of reflectors as claimed in claim 9 wherein the said blocking device is an electronic wave filter whereby specific infra-red or other waves can be blocked from reaching the electronic device.

12. A arrangement of reflectors as claimed in claim 9 wherein the said reflecting mirrors are prisms.

13. A arrangement of reflectors as claimed in claim 11 wherein the said wave filter is programmed with the wavelengths to be filtered out and blocked from reaching the said receiving eye.

14. A arrangement of reflectors as claimed in claim 11 wherein the said wave filter is capable of accepting instruction from the user to recognize the wavelength to be filtered out and blocked from reaching the said receiving eye.

15. A arrangement of reflectors as claimed in claim 11 wherein the said wave filter operates by emitting a disrupting constant light beam that prevents the unwanted waves from reaching the said receiving eye.

16. A arrangement of reflectors as claimed in claims 1 and 9 wherein the said reflecting mirrors are used to see the screen of the said electronic device, where the said screen faces in a direction not directly visible by a person standing next to the said electronic device.

17. A arrangement of reflectors as claimed in claims 3 and 11 wherein the said electronic wave filter is divided into two parts connected by an electronic cable wherein the one part is attached to an external face of the device of this invention in order to accept the remote control infra-red waves and the other part is attached to an internal face of the device of this invention positioned to be able to transmit the said instruction waves to the said receiving eye.

18. A arrangement of reflectors as claimed in claims 1 and 9 wherein the said electronic device is positioned at an angle other than vertical.

19. An electronic wave filter which is programmable to block out undesired instructions from a wave transmitter comprising a wave receiver, a processing wave filter and a wave transmitter.
